(19) United States
(12) Patent Application Publication
(10) Pub. No.: US 2011/0165310 A1
(43) Pub. Date: Jul. 7, 2011

(54) Juice Processing

(75) Inventors: Daniel J. Blase, St. Louis, MO (US); Cheriyan B. Thomas, Ellington, CT (US)

(73) Assignees: INNOVATIVE STRATEGIC DESIGN, LLC, Cincinnati, OH (US); INNOVATIVE PRODUCT MANAGEMENT, LLC, Columbus, OH (US)

(21) Appl. No.: 13/047,158

(22) Filed: Mar. 14, 2011

Related U.S. Application Data
(63) Continuation-in-part of application No. 11/881,364, filed on Jul. 26, 2007.

(51) Int. Cl. A23L 2/04; A23L 2/00; A23P 1/00; A23L 2/06

(52) U.S. Cl. 426/599; 426/590; 426/495

(57) ABSTRACT

A method for treating a sugar-containing natural consumable product for lowering its sugar content includes passing a stream of a sugar-containing natural consumable product into contact with a bed of ionic adsorbent material capable of chromatographically separating sugar from the natural consumable product; and chromatographically separating a sugar-diminished natural consumable product from the adsorbent bed. A high intensity natural and/or artificial sweetener can be added to the sugar-diminished beverage to produce a beverage product having similar flavor and nutritional content as the original beverage, but containing a lower amount of calories. The sugar-reduced beverage also can be used as a flavoring for the beverage and food industry; or as an ingredient component for reduced and full calorie foods (e.g., jellies, candies, etc.). The sugar-reduced beverage can be concentrated to a higher level using less energy as compared to standard juices.

### CROSS-REFERENCE TO RELATED APPLICATIONS

This application claims benefit of application Ser. No. 11/881,364, filed on Jul. 26, 2007; and of PCT application serial number PCT/US2006/003149 filed on Jan. 27, 2006, which claims priority on U.S. provisional application Ser. No. 60/648,183 filed on 28 Jan. 2005. The disclosures of these applications are expressly incorporate herein by reference.

### STATEMENT REGARDING FEDERALLY SPONSORED RESEARCH

Not applicable.

### BACKGROUND

The present disclosure relates generally to processing of a variety of ingestible liquid (fluent or flowable) beverages and more particularly to such beverages being substantially devoid of sugars.

Fruit and vegetable juices are widely used in the food and beverage industry as a juice, juice beverage, flavor, and/or ingredient component. A juice typically is defined by its brix content and is used either as single strength juice or juice concentrate. A “juice beverage” is defined as any product that contains a juice, but may contain less than 100% juice.

Juices are an excellent source of vitamins, minerals and other beneficial compounds. However, an 8-ounce (240 ml) glass of orange juice, for example, contains 110 calories, primarily from the 22 grams of sugar. Obesity and diabetes in the US are moving consumers towards low sugar, low calorie beverages. Although juice products have a high nutritional content, there has been a sharp decline in juice consumption recently due partially to its high calorie and sugar content. Today's low calorie juice beverages are primarily diluted juices with juice flavoring and do not contain the nutritional benefits of the natural whole juice.

Orange juice, as with most fruit and vegetable juices, is defined and regulated by its standard of identity. This is based on the brix (soluble solids; including fructose, sucrose, and glucose) of the juice. “Brix” is a refractive index scale for measuring the amount of sugar in a solution at a given temperature.

In particular, squeezing the liquid from the orange produces “Orange Juice”. The resulting juice is passed through a centrifuge or other process to remove small pieces of orange peel and excess pulp.

Orange Juice Concentrate is produced by passing finished juice over a heat exchanger to remove most (about 80% to about 90%) of the native water. The orange juice concentrate is stored frozen until needed. Frozen concentrate is shipped domestically and internationally to local and regional beverage plants where it is reconstituted (water is returned to the concentrate) to produce “Orange Juice” (100% Orange Juice; based on standard of identity) and “Orange Juice Beverages” (less then 100% Orange Juice; based on standard of identity). This process of juice concentration has a high-energy requirement and is, therefore, expensive. Frozen concentrate storage and shipment also is expensive due to its bulk.

Orange Juice also is sold as a single strength product and is labeled for the retail market as “Orange Juice not from Concentrate”. It is sold at a premium due to the higher quality, additional storage and transportation cost (single strength versus concentrate), and special (expensive) storage requirements.

In the present application, then, the terms “Orange Juice” and “Orange Juice Concentrate” will be used to signify their standard of identity.

There has not been any significant innovation in the juice industry in many years. The disclosed process will enable significant increase in juice consumption and provide an alternative to the traditional juices and the juice beverage due to the removal of unwanted sugars with retention of flavor and nutritional components.

Fruit and vegetable juices typically are used to produce flavor and ingredient components to enhance the natural qualities of consumer products. For example, orange juice could be added to a beverage to enhance the citrus flavor. Vegetable juices are added to foods to impart their natural flavor profile.

Heretofore, Efsthathiou (U.S. Pat. No. 4,676,988) has proposed to reducing the acid content of juices, milk, and juice/milk blends. Efsthathiou accomplishes this task by treating a juice concentrate with resins resulting in substantial absorption or extraction of sugars. Efsthathiou notes that the sugars can easily be recovered during the regeneration cycle of the resins by washing with distilled water. Efsthathiou explicitly refers to cation exchange resins and anion exchange resins (see, for example, col. 2, II. 55-62) and implicitly (via his examples) refers to the cation resins being in the hydrogen (H⁺) form and the anion resins being in the in the hydroxide (OH⁻) or free base forms. Efsthathiou explicitly rules out the use of the hydroxide form resins use, if reclamation of components is desired on the milk component. Such ionic removal or extraction process is much different than the chromatographic separation disclosed herein.

### BRIEF SUMMARY

A method for treating a sugar-containing natural consumable product for lowering its sugar content includes passing a stream of a sugar-containing natural consumable product into contact with a bed of ionic material capable of chromatographically separating sugar from the natural consumable product; and chromatographically separating a sugar-diminished natural consumable product (hereinafter, “SDP”) from the adsorbent bed. The resulting SDP stream can be used to produce, for example, a juice beverage, juice concentrate, flavoring, and/or ingredient component. In its broadest context, a “natural consumable product” will be treated for making a sugar-reduced consumable product suitable for use as a beverage, flavoring, ingredients, or (food) additive/supplement including dietary and nutritional supplements.

An organoleptically acceptable beverage can be produced from the sugar-reduced SDP stream by adding thereto a high intensity natural and/or artificial sweetener (e.g., sucralose, aspartame, saccharine, or the like) and/or a sugar (e.g., HFCS, sucrose, fructose, glucose, or the like). By adding a reduced calorie sweetener, a reduced calorie beverage is produced. This beverage will have most of the nutritional benefits of the original fruit or vegetable without the calories, since the sugar has been removed. It should be understood that not all of the sugar needs to be removed from the beverage subjected to the resin bed treatment, as only partial removal of sugar also reduces the calories of the beverage.

The SDP stream also can be used as a flavoring in beverages or foods, or as a replacement for single strength juice product where it is added primarily for the flavor and nutrition contribution. SDP also can be used as an ingredient for low calorie products (e.g., jellies, fillings, fruit preps, candies, cakes, or the like.).

SDP further can be concentrated by 10%-90% or more. This concentrate results in a significant reduction in volume compared to standard juice concentrates due to the reduction of sugars. Processing cost of concentrating juices is reduced significantly due to the lack of sugars in the juice streams. Sugar reduced SDP concentrates would result in significant less frozen shipping and frozen storage cost compared to standard concentrates due to the lower volume. Thermal, flavor, and nutritional degradation of the juice also is reduced since the concentration process requires less heat and time

The process includes one or more of the following benefits;
1. Low calorie beverage,
2. Low sugar beverage,
3. Beverage with similar nutritional content as the original juice with less sugar or calories,
4. Lower processing costs during the concentration process,
5. Lower frozen storage costs,
6. Lower frozen shipment costs,
7. Higher quality concentrates and beverages,
8. Lower bulk frozen flavor,
9. Lower bulk frozen ingredient.

### BRIEF DESCRIPTION OF THE DRAWINGS

For a fuller understanding of the nature and advantages of the present disclosure, reference should be made to the following detailed description taken in connection with the accompanying drawings, in which:

FIG. 1 is a simplified schematic of a simulated moving bed for a continuous process for taking feed orange juice and fractionating it into a sugar-enriched fraction and a sugar-starved fraction;

FIG. 2 is a graphic plot of the chromatographic separation in a packed column into two fractions, a sugar enriched fraction and a sugar starved fraction; and

FIGS. 3, 4, and 5 graphically plot Brix versus tube number for the tests reported in the Examples.

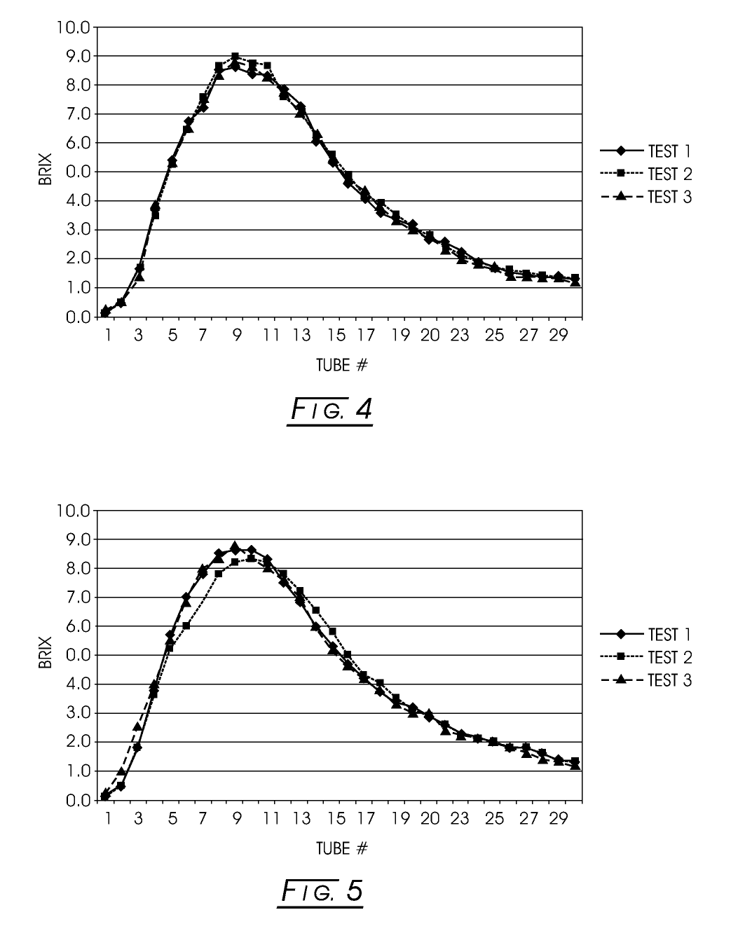

The drawings will be described in further detail below.

### DETAILED DESCRIPTION

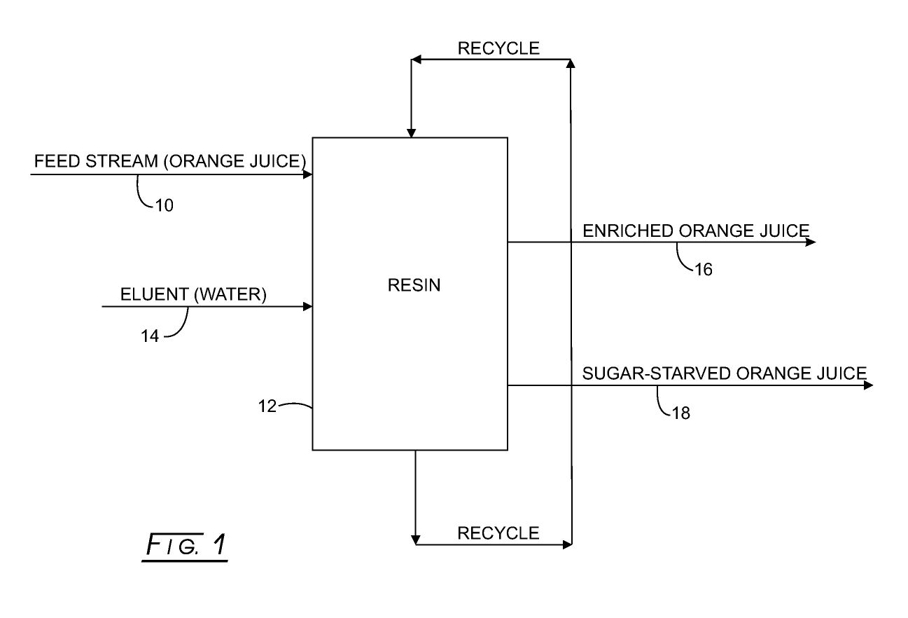

Referring to FIG. 1, a feed stream of orange juice or other composition disclosed herein, 10, has been pre-treated, such as being subject to centrifugation, filtration, or other operation to remove most, if you all, of the pulp. Feed stream 10 also may be passed through a filter (e.g., hollow fiber filter) to remove most of the pectin. Such pre-treating operations are optional.

Once feed stream 10 is ready, it is passed into a simulated moving bed housed within column, 12, and filled with resin beads having an affinity for sugars in feed stream 10. Suitable such resins include, for example, DOWEX MONOSPHERE 99 CA (supplied by Dow Chemical Company, Midland, Mich.) and DIAION UBK 555 (supplied by Mitsubishi Chemical Corporation) can be used. Withdrawn from column 12 is a sugar-enriched orange juice fraction, 16, and a sugar-starved orange juice fraction, 18. An eluent stream of water, 14, also may be passed into column 12 for assisting in the separation of fractions 16 and 18 in the simulated moving bed. A recycle stream, 20, is employed to improve process efficiency. For additional information on chromatographic separation, see C. F. Poole, “The Essence of Chromatography”, C F Poole, 2003, Elsevier Science B.V.

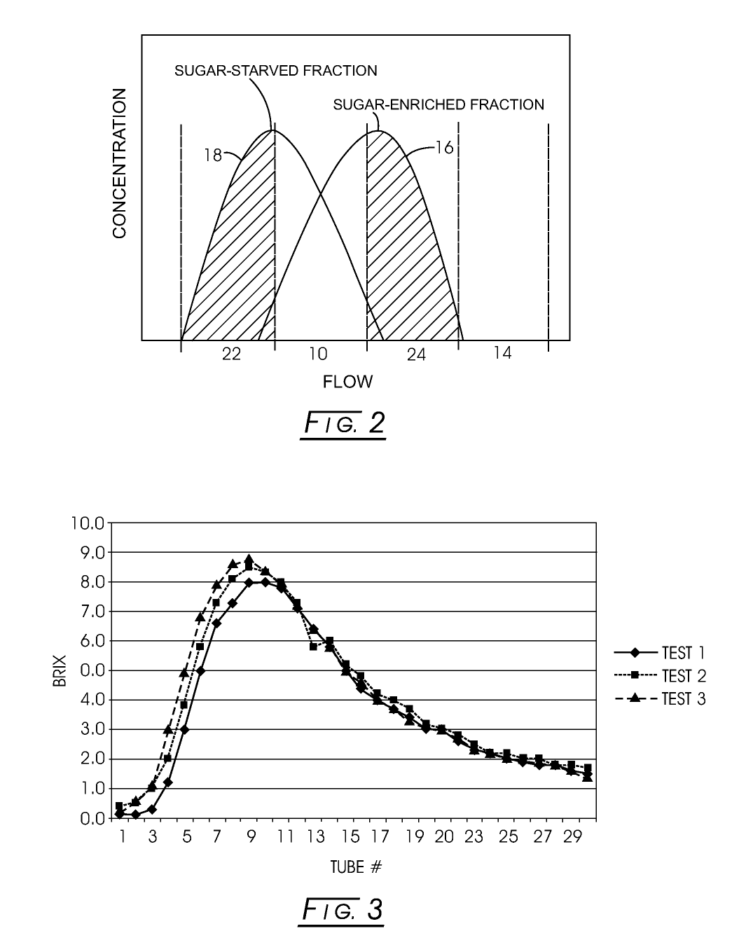

Chromatographic separation of an orange juice feed stream in a packed column is displayed graphically in FIG. 2. Product withdrawal of a sugar-starved orange juice fraction, 22, and a sugar-enriched orange juice fraction, 24, should be at a point in the column when the concentration of sugar in such fractions is minimal or maximal, respectively. Addition of feed stream 10 is located at the point in column 12 where the least separation of sugar-enriched orange juice stream 16 and sugar-starved orange juice stream 18 occurs. Water 14 is added to column 12 after removal of sugar-enriched orange juice stream 16 to maintain mass balance and constant flow during recycle.

Columns can be run in series, parallel, cascade, or the like, in conventional fashion for additional treating time, capacity, or for special affects. Potassium, sodium, and other forms of the resin also can be used.

Sugar-starved orange juice fraction or stream 18, no longer meets the standard of identity for “Orange Juice”. This stream can be used for producing, but not limited to:
1. orange Juice beverages;
2. low sugar/low calorie “Orange Juice Beverage with High Intensity Sweeteners”;
3. low sugar/low calorie “Orange Juice Flavor”;
4. low sugar/low calorie “Orange Juice Ingredient”;
5. low sugar/low calorie “Orange Juice Beverage Concentrate with High Intensity Sweeteners”;
6. low sugar/low calorie “Orange Juice Flavor Concentrate”;
7. low sugar/low calorie “Orange Juice Ingredient Concentrate”;
8. Juice concentrates (Orange Juice with reduced sugar recombined with sugars).

Sugar-enriched stream 16 can be used for sweetening a variety of foodstuffs, including sugar-starved juice stream 18.

While the process may be practiced using a chromatography separator (e.g., CSEP of Calgon Carbon Corporation), the process also may be a continuous process involving a semi-continuous process or continuous process using a packed bed or simulated moving bed.
1. Juice may be pre-processed to reduce the level of pulp, pectin or other components, which may interfere with the separation process.
2. The process may include filtration by hollow fiber, ultra filtration or other methods to reduce pulp, pectin or other components
3. The process results in a beverage with similar nutritional content as the original juice with less sugar or calories.
4. The process results in a flavor.
5. The process results in an ingredient component.
6. The process results in a concentration process, which significantly reduces thermal processing to concentrate the product.
7. The process results in a concentration process, which has a lower cost.
8. The process results in a concentrate, which reduces frozen storage cost.
9. The process results in a concentrate, which reduces frozen shipping cost.
10. The process results in a concentrate, which reduces aseptic processing requirements (volume and cost).

The skilled artisan will readily appreciate the differences and improves realized utilizing the disclosed chromatographic separation method compared to the prior art ionic extraction method, to with:
(a) ionic exchange using ionic exchange resins operates by the resin adsorbing the sugar and/or ionic components to be removed with later washing of the resin for recovery.
(b) chromatographic separation using chromatographic separating resins do not adsorb any sugar components (e.g., ions) and, hence, no washing of resin is needed nor would washing result in any recovery of a sugar component or ions from the process stream and, therefore, do not require, nor use, a recovery step.
(c) chromatographic separation does not remove sugars from the feed juice stream.
(d) rather, separation chromatography and/or size exclusion chromatography provides differentiated sugar rich and sugar poor regions within the process stream.

### Benefits to the Consumer

A beverage containing the SDP without-sugars, water, and a high intensity natural and/or artificial sweetener (i.e., sucralose or the like) produces a beverage that is parity in sensory evaluations versus its standard counterpart. The resulting beverage will contain most of the vitamins, minerals, and other beneficial compounds of the standard beverage without all the calories from sugar. Citrus pectin or some other carbohydrate (gums, etc.) may be added to give additional viscosity and mouth-feel.

Orange Juice consumption is declining in part due to the high calories of the beverage. A low calorie product will allow consumers the opportunity to consume a beverage with the goodness of Orange Juice without worry of additional calories of standard orange juice. Some of the benefits to the consumer are as follows;
1. Low calorie “Juice Beverage”.
2. Low sugar “Juice Beverage”.
3. “Juice Beverage” similar in nutrition to the standard juice, without all the sugar or calorie.
4. Higher quality concentrates and beverages.
5. Be able to drink more “juice” containing products.

### Benefit to the Manufacturer

SDP can be used to produce SDP concentrates, flavorings (i.e., beverages, etc.) and SDP without-sugar ingredient components (i.e., candies, etc.)

Concentrating standard sugar containing products is very expensive, partially due to the high sugar content resulting in high viscosity and high-energy requirements. By using SDP (low soluble solids), energy requirement will be significantly reduced. Less energy is required to concentrate low soluble solid solutions versus high soluble solid solutions. This thermal processing savings can range from about 10% to about 50% or even higher. The resulting SDP concentrate can be recombined with water and high intensity sweeteners to produce low calorie beverages.

SDP storage and shipping costs (frozen and refrigerated) for single strength and concentrate are significantly reduced by removing sugar. This savings can range from about 10% to about 70% or even higher.

The disclosed processing can be used with other fruit juices and vegetable juices, including, inter alia, cranberry, citrus, grape, apple, pineapple, tomato, carrot, or the like. “Beverage”, then, for present purposes is a broad term, comprehending a sugar-containing fluent (flowable) consumable product, including, for example, fruit juice, vegetable juice, and the like. Sugars for removal will depend upon the beverage and includes, inter alia, mono-saccharides, di-saccharides, and poly-saccharides. Appropriate beads for such chromatographic separation will be chosen based on the specific sugars and beverages being treated and include, inter alia, resins, ceramics, inorganics, and like beads, often presented as a packed bed. Following are some of the benefits to the manufacturer.
1. Market a new low calorie beverage with true consumer benefits.
2. Market a new low sugar beverage with true consumer benefits.
3. Market a new beverage similar in nutrition to the standard juice, without all the sugar or calorie.
4. Higher quality concentrates and beverages.
5. Lower processing costs during the concentration process.
6. Lower frozen storage costs.
7. Lower frozen shipment costs.
8. Lower aseptic processing requirement (volume and cost).
9. Market New products such as, for example,
   a. SDP beverages;
   b. low sugar/low calorie SDP Beverage with High Intensity Sweeteners”;
   c. low sugar/low calorie “SDP Flavor”;
   d. low sugar/low calorie “SDP Ingredient”;
   e. low sugar/low calorie “SDP Beverage Concentrate with High Intensity Sweeteners”;
   f. low sugar/low calorie “SDP Flavor Concentrate”;
   g. low sugar/low calorie “SDP Ingredient Concentrate”;
   h. Juice concentrates (SDP with reduced sugar recombined with sugars).

The following examples show how the present process has been practiced, but they should not be construed as limiting. In this application all units are in the metric system and all amounts and percentages are by weight, unless otherwise expressly indicated.

### Examples

### Objective

Separate (fractionate) sugars from fructose solution, Orange Juice and Apple Juice, using Dowex® Monosphere® 99CA/320 Separation Resin (see “Chromatographic Separation of Fructose and Glucose with DOWEX MONOSPHERE Ion Exchange Resins Technical Manual”, The Dow Chemical Company, Form No. 177-01566-0209.

### Experimental Procedure

### Resin Conditioning:

Dowex® Monosphere® 99CA/320 Separation Resin (Supelco Inc.) was conditioned by transferring moist resin to a glass container with distilled water. The resin was mixed slowly in the water and allowed to set for 3 minutes before the supernatant was decanted. The procedure was repeated three times before the resin was considered conditioned.

### Column Preparation:

Conditioned Dowex® Monosphere® 99CA/320 Separation Resin slurry was added to a column containing 30 cm of distilled water. The outlet tube was opened to prevent overflow and additional resin was added to continue packing the column. Packing of the resin bed was a continuous process in order to produce a homogeneous column. The water level was maintained above the resin surface throughout this process. The final resin bed height was 63.5 cm with a diameter of 3 cm.

### Sample Preparation:

Three samples were prepared. The first sample was a fructose solution to simulate a simple juice without native pulp, pectin, or other materials that may interfere with separation. The second and third samples were clarified Orange Juice and commercially available Apple Juice concentrate, respectively.

The fructose solution was prepared by combining 144 gm crystalline fructose, 200 ml of room temperature distilled water (Great Value), and one drop of blue color (McCormick Neon Food Colors). The solution was manually stirred until the crystalline fructose was dissolved. The resulting solution had a brix of 42.3° as measured with a hand held refractometer (Epic Inc, 30%-60%).

Clarified Orange Juice concentrate (Cargill Inc.) was tempered to 73° F. and stirred to maintain a homogenous sample. The Clarified Orange Juice Concentrate was determined to be 68.2° brix as measured with a hand held refractometer (Epic Inc, 30%-60%). The clarified concentrate was diluted with distilled water to a final brix of 42.0°.

Apple Juice concentrate (Langers 100% Apple Juice) was tempered to 73° F. and stirred to maintain a homogenous sample. The Apple Juice was determined to be 42.3° brix as measured with a hand held refractometer (Epic Inc, 30%-60%).

### Fractionation Procedure:

The water level was lowered to the surface of the resin before a 30 ml sample of the test solution was added to the top of the column. Once the entire sample entered the resin bed, the elutant was collected. After 125 ml of elutant was collected, the remaining liquid was collected manually in glass test tubes. Thirty, 10.3 ml samples were collected from each test. The column was reconditioned by passing 200 ml of distilled water after each test. The three samples, Fructose solution, Orange Juice, and Apple Juice, were run in triplicate. The column flow rate was maintained at 3.7 ml/min. for all tests.

### Results:

The Fructose solution was fractionated from the blue color and fructose (Table 1). Tubes 3 and 4 showed the maximum color. Tube # 9 showed the highest brix, as measured with a hand held refractometer (Reichert model 10430 0-30 Brix). The trial was run in triplicate and the resulting data shows very good correlation between tests (Table 1).

Orange Juice was fractionated into “juice with reduced sugars” and sugars (Table 2). Tube # 4 showed the maximum orange color, orange flavor, and aroma. Tube # 9 showed the highest brix, as measured with a hand held refractometer (Reichert model 10430 0-30 Brix). The Orange Juice trial was run in triplicate and the resulting data shows very good duplication (Table 2).

Apple Juice was fractionated into “juice with reduced sugar” and sugar (Table 3). Tube # 4 showed the maximum brown color, apple flavor, and aroma. Tube # 9 showed the highest brix, as measured with a hand held refractometer (Reichert model 10430 0-30 Brix). The Apple Juice trial was run in triplicate and the resulting data shows very good duplication (Table 3).

### Conclusion:

Fructose was separated from the fructose solution and sugars were separated from Orange Juice and Apple Juice with a DOWEX® MONOSPHERE® 99CA/320 separation resin column.

The “orange juice with reduced sugars” fractions contained orange color, orange flavor, and aroma, while the sugars containing tubes had minimal color, orange flavor, and aroma.

The “apple juice with reduced sugar” fractions contained brown color, apple flavor, and aroma, while the sugar containing tubes had minimal color, apple flavor, and aroma.

The process and system can be modified, for example, by using various resin type, resin size, resin porosity, column dimensions, flow rate, sample size, fluidized and packed bed etc. and, thereby, efficiently remove sugars from standard sugar containing product to achieve the desired sugar content. Cationic, Anionic, and Ion Exclusion Resins as well as other resins commercially available can be used.

TABLE 1
Crystalline Fructose (Brix)

| Tube | Test 1 | Test 2 | Test 3 |
|---|---|---|---|
| 1 | 0.1 | 0.4 | 0.3 |
| 2 | 0.1 | 0.5 | 0.6 |
| 3 | 0.3 | 1.0 | 1.1 |
| 4 | 1.2 | 2.0 | 3.0 |
| 5 | 3.0 | 3.8 | 4.9 |
| 6 | 5.0 | 5.8 | 6.8 |
| 7 | 6.6 | 7.3 | 7.9 |
| 8 | 7.3 | 8.1 | 8.6 |
| 9 | 8.0 | 8.5 | 8.8 |
| 10 | 8.0 | 8.3 | 8.4 |
| 11 | 7.8 | 8.0 | 8.0 |
| 12 | 7.1 | 7.3 | 7.2 |
| 13 | 6.4 | 5.8 | 6.4 |
| 14 | 5.8 | 6.0 | 5.8 |
| 15 | 5.0 | 5.2 | 5.0 |
| 16 | 4.4 | 4.8 | 4.6 |
| 17 | 4.0 | 4.2 | 4.0 |
| 18 | 3.7 | 4.0 | 3.7 |
| 19 | 3.4 | 3.7 | 3.3 |
| 20 | 3.0 | 3.2 | 3.1 |
| 21 | 3.0 | 3.0 | 3.0 |
| 22 | 2.6 | 2.8 | 2.7 |
| 23 | 2.3 | 2.5 | 2.3 |
| 24 | 2.2 | 2.2 | 2.2 |
| 25 | 2.0 | 2.2 | 2.0 |
| 26 | 1.9 | 2.0 | 2.0 |
| 27 | 1.8 | 2.0 | 1.9 |
| 28 | 1.8 | 1.8 | 1.8 |
| 29 | 1.6 | 1.8 | 1.6 |
| 30 | 1.5 | 1.7 | 1.4 |

TABLE 2
Orange Juice (Brix)

| Tube | Test 1 | Test 2 | Test 3 |
|---|---|---|---|
| 1 | 0.1 | 0.3 | 0.2 |
| 2 | 0.4 | 0.5 | 0.6 |
| 3 | 1.6 | 1.7 | 1.4 |
| 4 | 3.7 | 3.5 | 3.9 |
| 5 | 5.4 | 5.3 | 5.3 |
| 6 | 6.8 | 6.5 | 6.5 |
| 7 | 7.2 | 7.6 | 7.6 |
| 8 | 8.4 | 8.7 | 8.5 |
| 9 | 8.6 | 9.0 | 8.9 |
| 10 | 8.4 | 8.8 | 8.7 |
| 11 | 8.3 | 8.7 | 8.3 |
| 12 | 7.9 | 7.7 | 7.8 |
| 13 | 7.3 | 7.1 | 7.1 |
| 14 | 6.1 | 6.3 | 6.4 |
| 15 | 5.5 | 5.6 | 5.6 |
| 16 | 4.6 | 4.9 | 4.8 |
| 17 | 4.1 | 4.2 | 4.4 |
| 18 | 3.6 | 3.9 | 3.8 |
| 19 | 3.4 | 3.5 | 3.4 |
| 20 | 3.0 | 3.1 | 3.0 |
| 21 | 2.6 | 2.8 | 2.7 |
| 22 | 2.5 | 2.4 | 2.3 |
| 23 | 2.2 | 2.1 | 2.0 |
| 24 | 1.9 | 1.9 | 1.8 |
| 25 | 1.6 | 1.7 | 1.6 |
| 26 | 1.5 | 1.6 | 1.4 |
| 27 | 1.4 | 1.5 | 1.4 |
| 28 | 1.3 | 1.4 | 1.3 |
| 29 | 1.3 | 1.4 | 1.3 |
| 30 | 1.2 | 1.3 | 1.0 |

TABLE 3
Apple Juice (Brix)

| Tube | Test 1 | Test 2 | Test 3 |
|---|---|---|---|
| 1 | 0.2 | 0.1 | 0.3 |
| 2 | 0.4 | 0.5 | 1.0 |
| 3 | 1.8 | 1.8 | 2.6 |
| 4 | 3.8 | 3.6 | 4.0 |
| 5 | 5.7 | 5.2 | 5.5 |
| 6 | 7.0 | 6.0 | 7.0 |
| 7 | 7.8 | 6.8 | 8.0 |
| 8 | 8.5 | 7.8 | 8.3 |
| 9 | 8.6 | 8.2 | 8.8 |
| 10 | 8.6 | 8.3 | 8.3 |
| 11 | 8.3 | 8.2 | 8.0 |
| 12 | 7.5 | 7.8 | 7.6 |
| 13 | 6.8 | 7.2 | 7.0 |
| 14 | 6.0 | 6.5 | 6.0 |
| 15 | 5.3 | 5.8 | 5.2 |
| 16 | 4.7 | 5.0 | 4.6 |
| 17 | 4.2 | 4.3 | 4.2 |
| 18 | 3.7 | 4.0 | 3.8 |
| 19 | 3.3 | 3.5 | 3.3 |
| 20 | 3.2 | 3.1 | 3.0 |
| 21 | 2.8 | 2.9 | 3.0 |
| 22 | 2.6 | 2.6 | 2.4 |
| 23 | 2.3 | 2.2 | 2.2 |
| 24 | 2.1 | 2.1 | 2.1 |
| 25 | 2.0 | 2.0 | 2.0 |
| 26 | 1.8 | 1.8 | 1.8 |
| 27 | 1.8 | 1.8 | 1.6 |
| 28 | 1.6 | 1.6 | 1.4 |
| 29 | 1.4 | 1.3 | 1.3 |
| 30 | 1.3 | 1.3 | 1.2 |

While the process and products have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. All citations referred herein are expressly incorporated herein by reference.

We claim:

1. A method for treating a sugar-containing natural consumable product for lowering its sugar content, comprising the steps of:
(a) passing a stream of a sugar-containing natural consumable product into contact with a bed of material capable of chromatographically separating sugar from the natural consumable product; and
(b) chromatographically separating a sugar-diminished natural consumable product from the bed.

2. The method of claim 1, wherein said sugar-containing natural consumable product is one or more of a beverage, flavoring, food ingredient, or dietary supplement, or nutritional supplement.

3. The method of claim 1, wherein said sugar is one or more of a mono-saccharide, di-saccharide, or poly-saccharide.

4. The method of claim 3, wherein said sugar is one or more of sucrose, fructose, or glucose.

5. The method of claim 4, wherein said sugar-containing natural consumable product is one or more of a fruit juice or vegetable juice.

6. The method of claim 5, wherein said juice is a citrus juice or a berry juice.

7. The method of claim 5, wherein said juice is one or more of orange juice, cranberry juice, grape juice, apple juice, pineapple juice, tangerine juice, grapefruit juice, pomegranate juice, cherry juice, strawberry juice, tomato juice, celery juice, or carrot juice.

8. The method of claim 1, wherein said sugar-diminished natural consumable product in step (b) is subjected to step (a) a plurality of times.

9. The method of claim 1, wherein said bed is one or more of resinous beads, organic beads, ceramic beads, or inorganic beads.

10. The method of claim 1, wherein said bed is housed in a vessel through which said stream is passed.

11. The method of claim 1, which is one or more of a semi-continuous process or continuous process using a packed bed or simulated moving bed.

12. The method of claim 1, wherein said bed material is one or more of ionic beads, affinity beads, or size exclusion beads.

13. The method of claim 1, wherein said stream in step (a) has been pretreated to one or more reduce the level of a component, dilute said stream, or concentrate said stream.

14. The method of claim 1, wherein the sugar-diminished natural consumable product in step (b) is concentrated.

15. A sugar-diminished beverage prepared by the process of claim 1.

16. A sugar-diminished beverage prepared by the process of claim 2.

17. A sugar-diminished beverage prepared by the process of claim 5.

18. A sugar-diminished beverage prepared by the process of claim 6.

19. A sugar-diminished beverage prepared by the process of claim 7.

20. A sugar-diminished beverage prepared by the process of claim 8.
